(19) United States
(12) Patent Application Publication
(10) Pub. No.: US 2021/0407302 A1
(43) Pub. Date: Dec. 30, 2021

(54) SYSTEM OF MULTI-DRONE VISUAL CONTENT CAPTURING

(71) Applicant: Sony Group Corporation, Tokyo (JP)

(72) Inventors: Cheng-Yi Liu, San Jose, CA (US); Alexander Berestov, San Jose, CA (US)

(73) Assignee: Sony Group Corporation, Tokyo (JP)

(21) Appl. No.: 16/917,013

(22) Filed: Jun. 30, 2020

(51) Int. Cl. G08G 5/00; G05D 1/00; G05D 1/10; B64C 39/02; G06T 7/579

(52) U.S. Cl. CPC G08G 5/0039; G08G 5/0069; G05D 1/0044; G06T 2207/30244; B64C 39/024; G06T 7/579; B64C 2201/127; G05D 1/104

(57) ABSTRACT

A system of imaging a scene includes a plurality of drones, each drone moving along a corresponding flight path over the scene and having a drone camera capturing, at a corresponding first pose and first time, a corresponding first image of the scene; a fly controller that controls the flight path of each drone, in part by using estimates of the first pose of each drone camera provided by a camera controller, to create and maintain a desired pattern of drones with desired camera poses; and the camera controller, which receives, from the drones, a corresponding plurality of captured images, processing the received images to generate a 3D representation of the scene as a system output, and to provide the estimates of the first pose of each drone camera to the fly controller. The system is fully operational with as few as one human operator.

### BACKGROUND

The increasing availability of drones equipped with cameras has inspired a new style of cinematography based on capturing images of scenes that were previously difficult to access. While professionals have traditionally captured high-quality images by using precise camera trajectories with well controlled extrinsic parameters, a camera on a drone is always in motion even when the drone is hovering. This is due to the aerodynamic nature of drones, which makes continuous movement fluctuations inevitable. If only one drone is involved, it is still possible to estimate camera pose (a 6D combination of position and orientation) by simultaneous localization and mapping (SLAM), a technique which is well known in the field of robotics. However, it is often desirable to employ multiple cameras at different viewing spots simultaneously, allowing for complex editing and full 3D scene reconstruction. Conventional SLAM approaches work well for single-drone, single-camera situations but are not suited for the estimation of all the poses involved in multiple-drone or multiple-camera situations.

Other challenges in multi-drone cinematography include the complexity of integrating the video streams of images captured by the multiple drones, and the need to control the flight paths of all the drones such that a desired formation (or swarm pattern), and any desired changes in that formation over time, can be achieved. In current practice for professional cinematography involving drone, human operators have to operate two separate controllers on each drone, one controlling flight parameters, and one controlling camera pose. There are many negative implications: for the drones in terms of their size, weight and cost; for reliability of the system as a whole; and for the quality of the output scene reconstructions.

There is, therefore, a need for improved systems and methods for integrating images captured by cameras on multiple, moving drones, and for accurately controlling those drones (and possibly the cameras independently of the drones), so that the visual content necessary to reconstruct the scene of interest can be efficiently captured and processed. Ideally, the visual content integration would be done automatically, at an off-drone location, and the controlling, also performed at an off-drone location but not necessarily the same one, would involve automatic feedback control mechanisms, to achieve high precision in drone positioning, adaptive to aerodynamic noise, due to factors such as wind. It may also sometimes be beneficial to minimize the number of human operators required for system operation.

### SUMMARY

Embodiments generally relate to methods and systems for imaging a scene in 3D, based on images captured by multiple drones.

In one embodiment, a system comprises a plurality of drones, a fly controller and a camera controller, wherein the system is fully operational with as few as one human operator. Each drone moves along a corresponding flight path over the scene, and each drone has a drone camera capturing, at a corresponding first pose and a corresponding first time, a corresponding first image of the scene. The fly controller controls the flight path of each drone, in part by using estimates of the first pose of each drone camera provided by a camera controller, to create and maintain a desired pattern of drones with desired camera poses over the scene. The camera controller receives, from the plurality of drones, a corresponding plurality of captured images of the scene, processes the received images to generate a 3D representation of the scene as a system output, and provides the estimates of the first pose of each drone camera to the fly controller.

In another embodiment, a method of imaging a scene comprises: deploying a plurality of drones, each drone moving along a corresponding flight path over the scene, and each drone having a camera capturing, at a corresponding first pose and a corresponding first time, a corresponding first image of the scene; using a fly controller to control the flight path of each drone, in part by using estimates of the pose of each camera provided by a camera controller, to create and maintain a desired pattern of drones with desired camera poses over the scene; and using the camera controller to receive, from the plurality of drones, a corresponding plurality of captured images of the scene, and to process the received images to generate a 3D representation of the scene as a system output, and to provide the estimates of the pose of each camera to the fly controller. No more than one human operator is needed for full operation of the method.

In another embodiment, an apparatus comprises one or more processors; and logic encoded in one or more non-transitory media for execution by the one or more processors. When executed, the logic is operable to image a scene by: deploying a plurality of drones, each drone moving along a corresponding flight path over the scene, and each drone having a camera capturing, at a corresponding first pose and a corresponding first time, a corresponding first image of the scene; using a fly controller to control the flight path of each drone, in part by using estimates of the pose of each camera provided by a camera controller, to create and maintain a desired pattern of drones with desired camera poses over the scene; and using the camera controller to receive, from the plurality of drones, a corresponding plurality of captured images of the scene, and to process the received images to generate a 3D representation of the scene as a system output, and to provide the estimates of the pose of each camera to the fly controller. No more than one human operator is needed for full operation of the apparatus to image the scene.

A further understanding of the nature and the advantages of particular embodiments disclosed herein may be realized by reference of the remaining portions of the specification and the attached drawings.

### BRIEF DESCRIPTION OF THE DRAWINGS

FIG. 1 illustrates imaging a scene according to some embodiments.

FIG. 2 illustrates imaging a scene according to the embodiments of FIG. 1.

FIG. 3 illustrates an example of how a drone agent may function according to some embodiments.

FIG. 4 illustrates an overview of the computation of transforms between a pair of drone cameras according to some embodiments.

FIG. 5 presents mathematical details of a least squares method applied to estimate the intersection of multiple vectors between two camera positions according to some embodiments.

FIG. 6 shows how an initial solution to scaling may be achieved for two cameras, according to some embodiments.

FIG. 7 shows how an initial rotation between coordinates for two cameras may be calculated, according to some embodiments.

FIG. 8 summarizes the final step of the calculation to fully align the coordinates (position, rotation and scaling) for two cameras, according to some embodiments.

FIG. 9 illustrates how a drone agent generates a depth map according to some embodiments.

FIG. 10 illustrates interactions between the fly controller and the camera controller in some embodiments.

FIG. 11 illustrates how flight and pose control for a swarm of drones is achieved according to some embodiments.

FIG. 12 illustrates high-level data flow between components of the system in some embodiments.

### DETAILED DESCRIPTION OF EMBODIMENTS

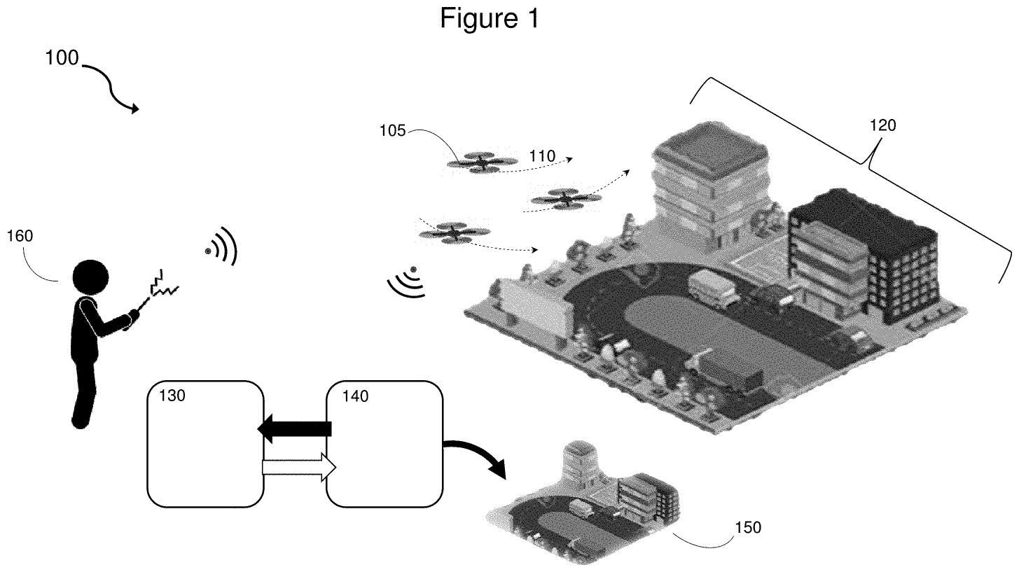

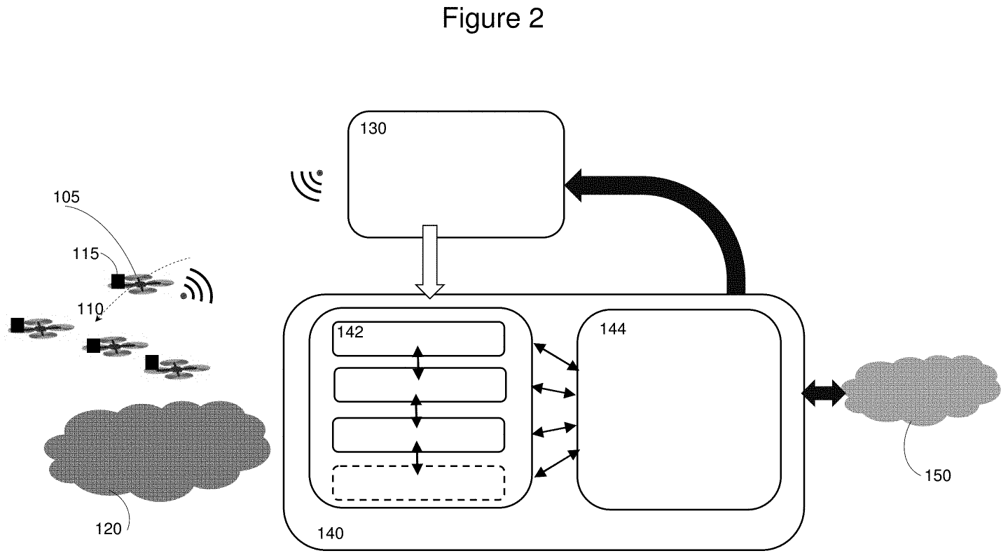

FIG. 1 illustrates a system 100 for imaging a scene 120, according to some embodiments of the present invention. FIG. 2 illustrates components of system 100 at a different level of detail. A plurality of drones is shown, each drone 105 moving along a corresponding path 110. FIG. 1 shows fly controller 130 operated by a human 160, in wireless communication with each of the drones. The drones are also in wireless communication with camera controller 140, transmitting captured images thereto. Data are sent from camera controller 140 to fly controller 130 to facilitate flight control. Other data may optionally be sent from fly controller 130 to camera controller 140 to facilitate image processing therewithin. System output is provided in the form of a 3D reconstruction 150 of scene 120.

FIG. 2 shows some of the internal organization of camera controller 140, comprising a plurality of drone agents 142 and a global optimizer 144, and flows of data, including feedback loops, between components of the system. The scene 120 and scene reconstruction 150 are represented in a more abstract fashion than in FIG. 1, for simplicity.

Each drone agent 142 is “matched up” with one and only one drone, receiving images from a drone camera 115 within or attached to that drone 105. For simplicity, FIG. 2 shows the drone cameras in the same relative positions and orientations on the various drones, but this is not necessarily the case in practice. Each drone agent processes each image (or frame from a video stream) received from the corresponding drone camera (in some cases in combination with fly command information received from fly controller 130) along with data characterizing the drone, drone camera and captured images, to generate (for example, using the SLAM technique) an estimate of drone camera pose in a coordinate frame local to that drone, pose being defined for the purposes of this disclosure as a combination of 3D position and 3D orientation. The characteristic data mentioned above typically includes drone ID, intrinsic camera parameters, and image capture parameters such as image timestamp, size, coding, and capture rate (fps).

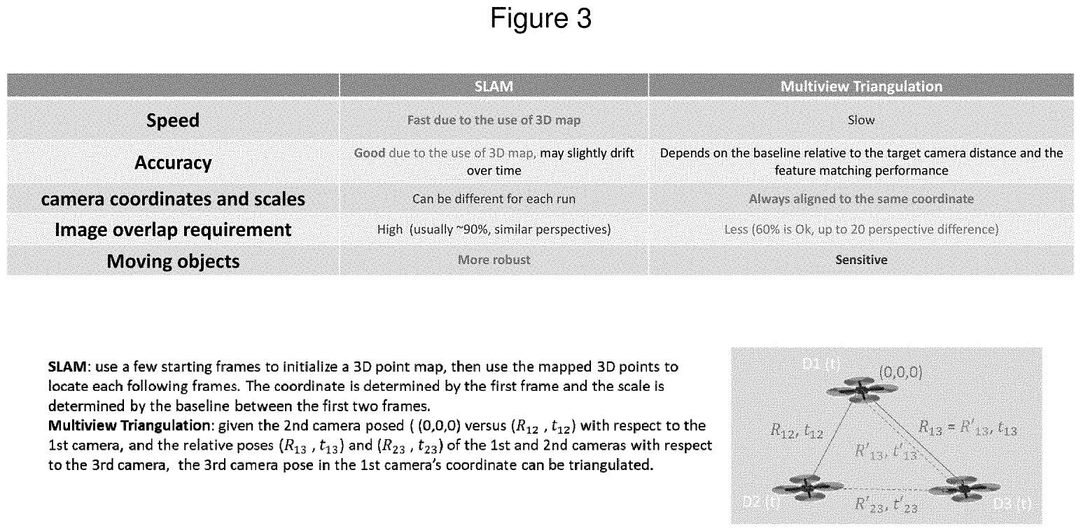

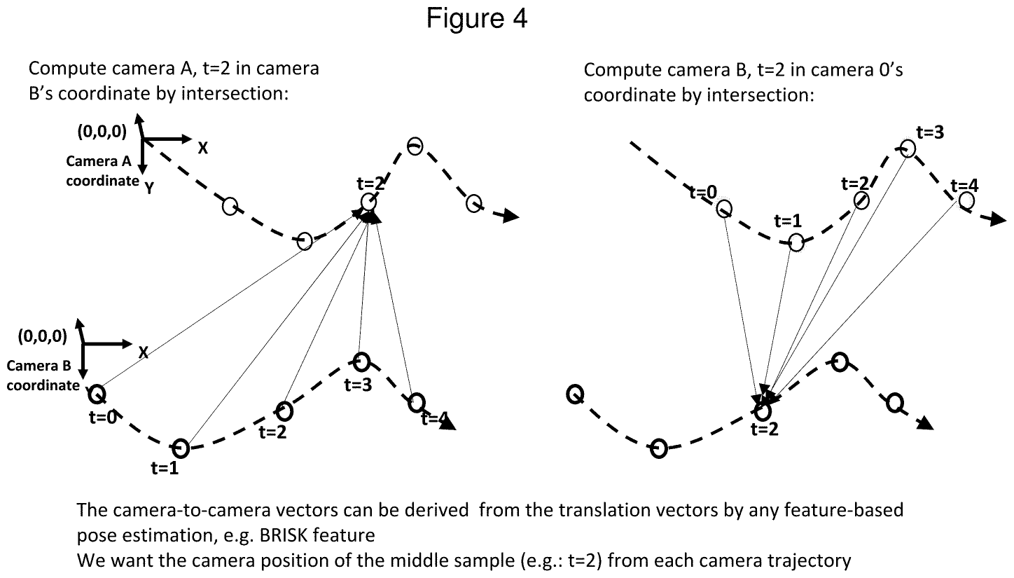

Each drone agent then collaborates with at least one other drone agent to compute a coordinate transformation specific to its own drone camera, so that the estimated camera pose can be expressed in a global coordinate system, shared by each of the drones. The computation may be carried out using a novel robust coordinate aligning algorithm, discussed in more detail below, with reference to FIGS. 3 and 4.

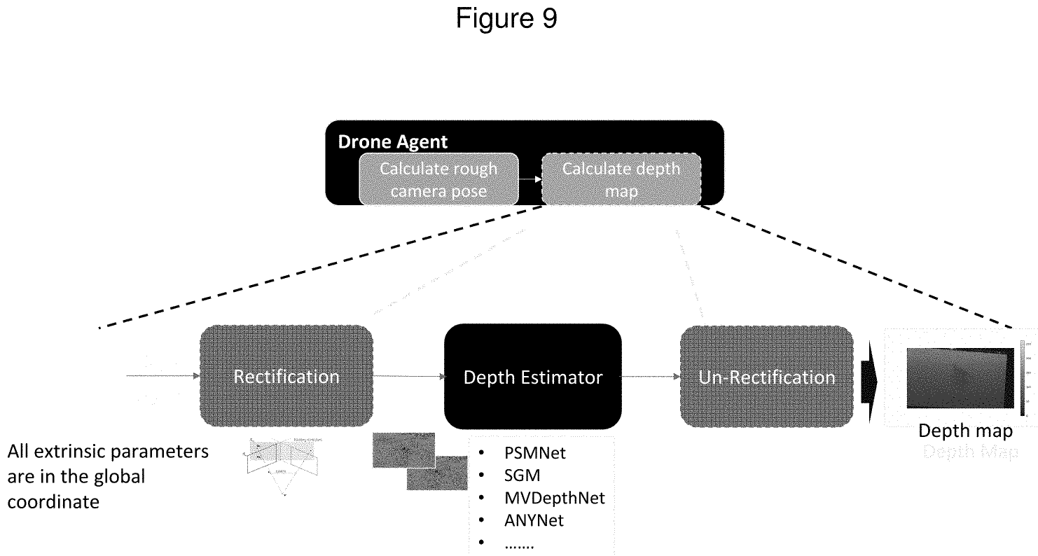

Each drone agent also generates a dense¹ depth map of the scene 120 as viewed by the corresponding drone camera for each pose from which the corresponding image was captured. depth map is calculated and expressed in the global coordinate system. In some cases, the map is generated by the drone agent processing a pair of images received from the same drone camera at slightly different times and poses, with their fields of view overlapping sufficiently to serve as a stereo pair. Well known techniques may be used by the drone agent to process such pairs to generate corresponding depth maps, as indicated in FIG. 9, described below. In some other cases, the drone may include a depth sensor of some type, so that depth measurements are sent along with the RGB image pixels, forming an RGBD image (rather than a simple RGB one) that the drone agent processes to generate the depth map. In yet other cases, both options may be present, with information from a depth sensor being used as an adjunct to refine a depth map previously generated from stereo pair processing. Examples of in-built depth sensors include LiDAR systems, time-of-flight, and those provided by stereo-cameras. ¹The word “dense” is used herein to mean that the resolution of the depth map is equal or very close to the resolution of the RGB images from which it is derived. In general modalities like LiDAR or RGB-D generate a depth map at a much lower resolution (smaller than VGA) than RGB. Visual keypoint-based methods generate even more sparse points with depth.

Each drone agent sends its own estimate of drone camera pose and the corresponding depth map, both in global coordinates, to global optimizer 144, along with data intrinsically characterizing the corresponding drone. On receiving all these data and an RGB image from each of the drone agents, global optimizer 144 processes these data collectively, generating a 3D point cloud representation that may be extended, corrected, and refined over time as more images and data are received. If a keypoint of an image is already present in the 3D point cloud, and a match is confirmed, the keypoint is said to be “registered”. The main purposes of the processing are to validate 3D point cloud image data across the plurality of images, and to adjust the estimated pose and depth map for each drone camera correspondingly. In this way, a joint optimization may be achieved of the “structure” of the imaged scene reconstruction, and the “motion” or positioning in space and time of the drone cameras.

The global optimization depends in part on the use of any one of various state-of-the-art SLAM or Structure from Motion (SfM) optimizers now available, for example the graph-based optimizer BundleFusion, that generate 3D point cloud reconstructions from a plurality of images captured at different poses.

In the present invention, such an optimizer is embedded in a process-level iterative optimizer, sending updated (improved) camera pose estimates and depth maps to the fly controller after each cycle, which the fly controller can use to make adjustments to flight path and pose as and when necessary. Subsequent images sent by the drones to the drone agents are then processed by the drone agents as described above, involving each drone agent collaborating with at least one other, to yield further improved depth maps and drone camera pose estimates that are in turn sent on to the global optimizer, to be used in the next iterative cycle, and so one. Thus the accuracy of camera pose estimates and depth maps are improved, cycle by cycle, in turn improving the control of the drones' flight paths and the quality of the 3D point cloud reconstruction. When this reconstruction is deemed to meet a predetermined threshold of quality, the iterative cycle may cease, and the reconstruction at that point provided as the ultimate system output. Many applications for that output may readily be envisaged, including, for example, 3D scene reconstruction for cinematography, or view change experience.

Further details of how drone agents 142 shown in system 100 operate in various embodiments will now be discussed.

The problem of how to control the positioning and motion of multiple drone cameras is addressed in the present invention by a combination of SLAM and MultiView Triangulation (MVT). FIG. 3 shows the strengths and weaknesses of the two techniques taken separately, and details of one embodiment of the proposed combination, which assumes that image sequences (or videos) have already been temporally synchronized, involves first running a SLAM process (e.g.: ORBSLAM2) on each drone to generate the local drone camera poses at each image (local SLAM poses in the following), then load for each drone a few (for example, 5) RGB image frames and their corresponding local SLAM poses. This determines consistent “local” coordinates and “local” scale for that drone camera. Next, a robust MT algorithm is run for a plurality of drones—FIG. 4 schematically illustrates how transforms (rotation, scale, and translation) needed to align a second drone's local SLAM poses to the coordinate defined by a first drone's SLAM may be computed. This is then extended to each of the other drones in the plurality. Then the transform appropriate for each local SLAM pose is applied. The result is that spatial and temporal consistency are achieved for the images captured from the entire plurality of drone cameras.

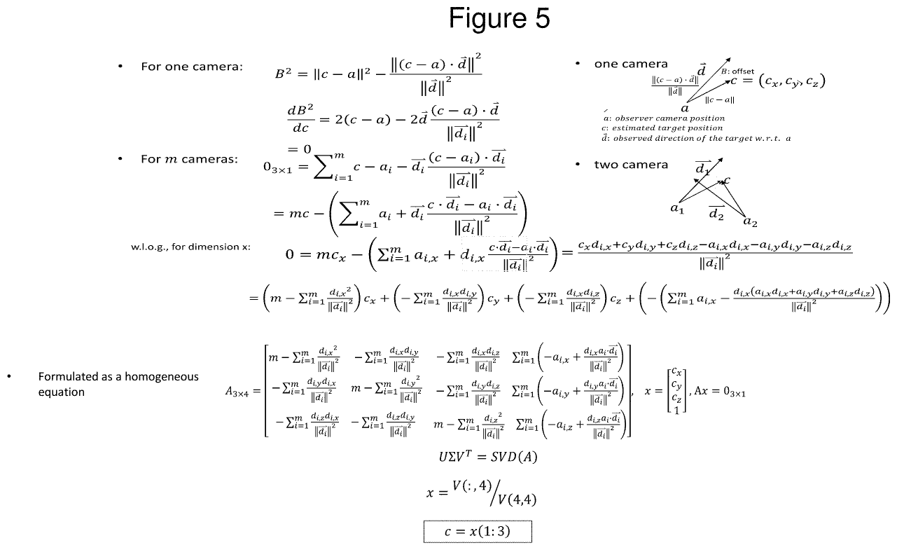

Mathematical details of the steps involved in the various calculations necessary to determining the transforms between two cameras are presented in FIGS. 5-8.

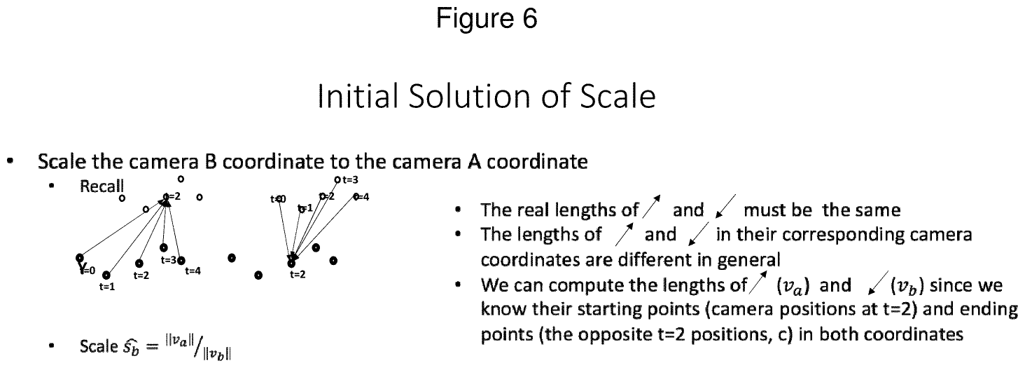

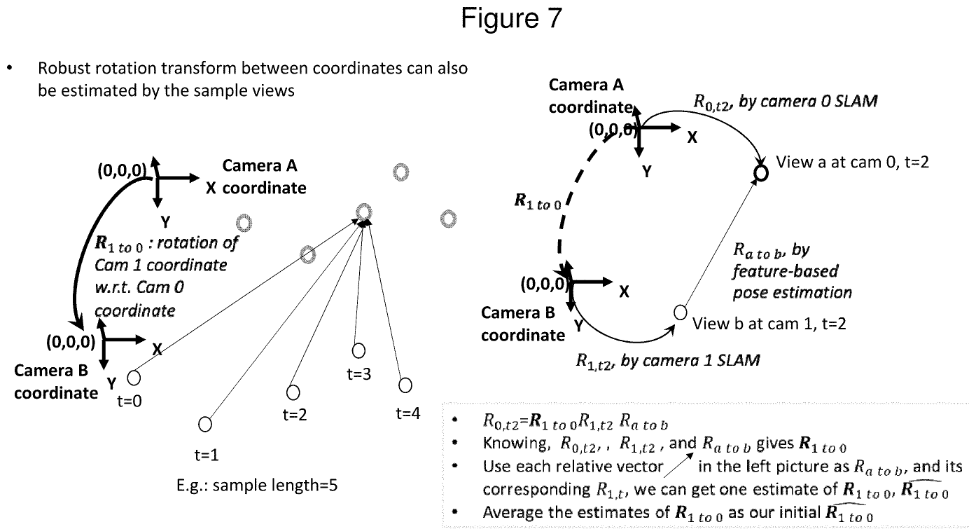

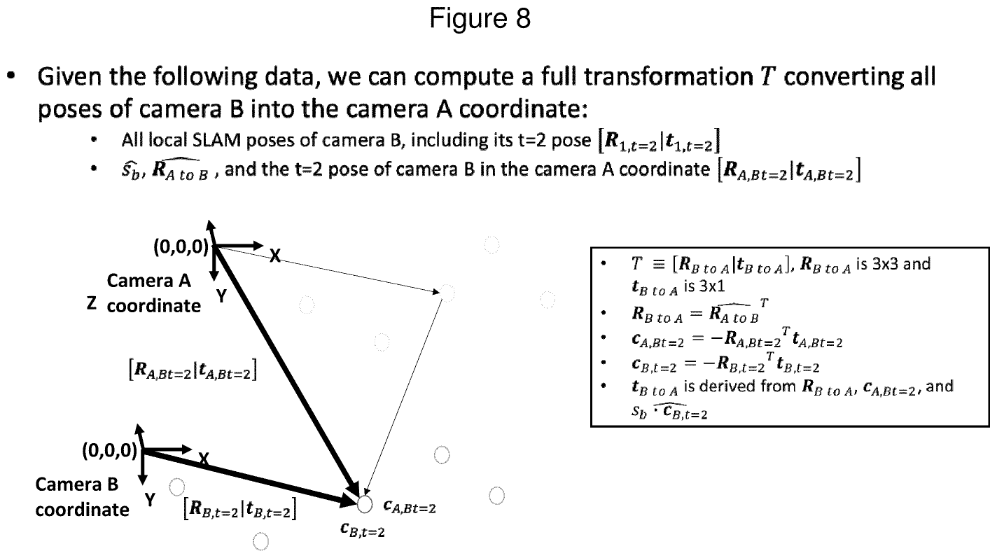

FIG. 5 shows how a least squares method may be applied to estimate the intersection of multiple vectors between camera positions. FIG. 6 shows how an initial solution to scaling may be achieved for two cameras. FIG. 7 shows how an initial rotation between coordinates for two cameras may be calculated. To guarantee that the rotation matrix calculated is unbiased averaging is done over all 3 rotation degrees of freedom, using techniques well known in the art. FIG. 8 summarizes the final step of the calculation to fully align the coordinates (position, rotation and scaling) for two cameras.

For simplicity, one of the drone agents may be considered the “master” drone agent, representing a “master” drone camera, whose coordinates whose coordinates may be considered to be the global coordinates, to which all the other drone camera images are aligned using the techniques described above.

FIG. 9 illustrates in schematic form, internal functional steps a drone agent may perform after techniques such as those described above are used to align the corresponding camera's images to the master drone camera and in the process roughly estimate the corresponding camera pose. The post-pose-estimation steps, represented in the four blocks in the lower part of the picture, generate a depth map based on a pseudo-stereo pair of consecutively captured images, say the first image and the second image, according to some embodiments. The sequence of operations then carried out is image rectification (comparing images taken by the drone camera at slightly different times), depth estimation using any of various well-known tools such as PSMnet, SGM etc., and finally Un-Rectification to assign the calculated depths to pixels of the first image of the pair.

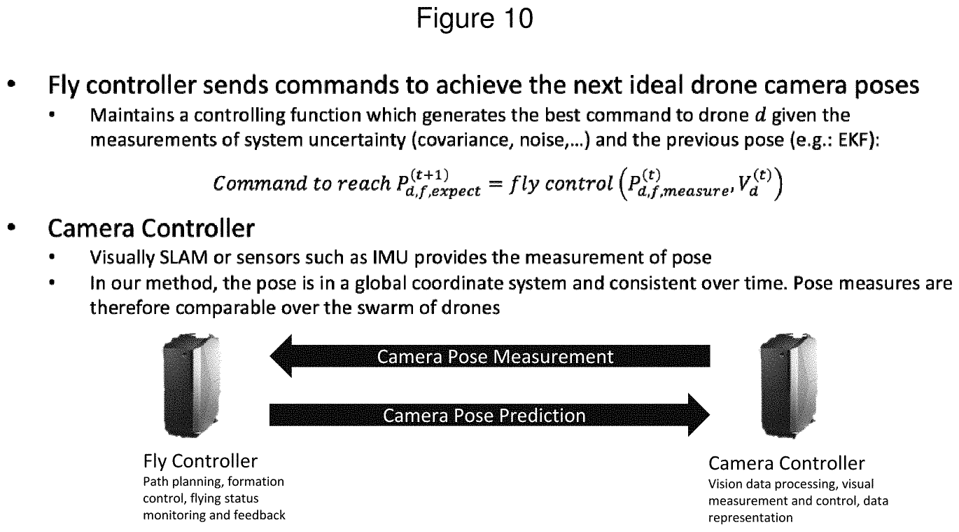

FIG. 10 summarizes high level aspects of the interaction between the fly controller and the camera controller in some embodiments of system 100. These interactions take the form of a feedback loop between the fly controller and the camera controller, in which the fly controller uses the latest measured visual poses by the camera controller to update its controlling model, and the camera controller considers the commands sent by the flying controller in the SLAM computation of camera poses.

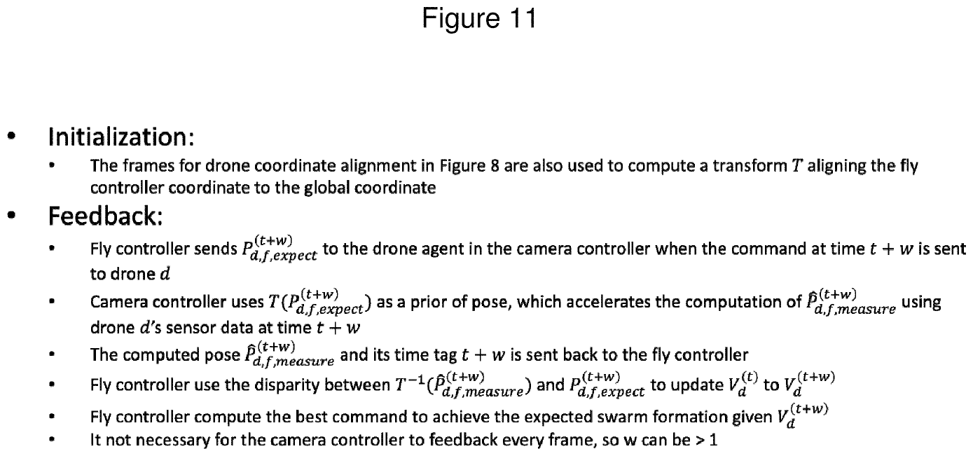

FIG. 11 provides more detail of a typical process to achieve control of the flight paths or poses of the plurality of drones—termed feedback swarm control as it depends on continuous feedback between the two controllers. Key aspects of the resulting, inventive system may be listed as follows.

(1) Control is rooted in the global optimizer's 3D map, which serves as the latest and most accurate visual reference for camera positioning. (2) The fly controller uses the 3D map information to generate commands to each drone that compensate for positioning errors made apparent in the map. (3) Upon the arrival of an image from the drone, the drone agent starts to compute the “measured” position “around” the expected position which can avoid unlikely solutions. (4) For drone swarm formation, the feedback mechanism always adjusts each drone's pose by visual measures, and the formation distortion due to drift is limited.

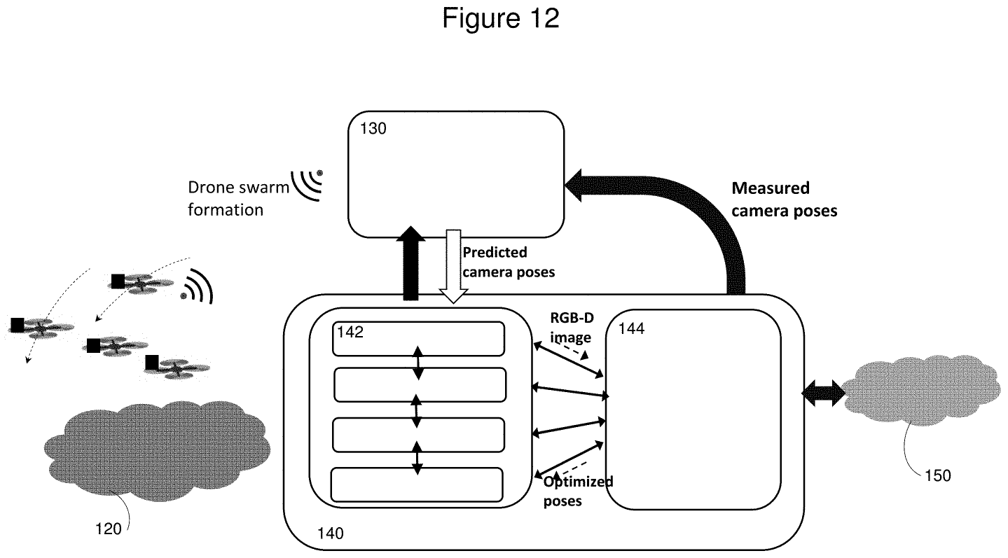

FIG. 12 labels information flow, showing the “outer” control feedback loop between fly controller 130 and camera controller 140, integrating those two major components of system 100, and “inner” feedback loops between global optimizer 144 and each drone agent 142. The global optimizer in camera controller 140 provides fully optimized pose data (rotation+position) to the fly controller as a channel of observations, and the fly controller considers these observations in its controlling parameter estimation, so the drone commands sent by the fly controller will respond to the latest pose uncertainties. Continuing the outer feedback loop, the fly controller shares its motion commands with the drone agents 142 in the camera controller. These commands are prior information to constrain and accelerate the optimization of next camera pose computation inside the camera controller. The inner feedback loops between global optimizer 144 and each drone agent 142 are indicated by the double headed arrows between those components in the Figure.

Embodiments described herein provide various benefits in systems and methods for the capture and integration of visual content using a plurality of camera-equipped drones. In particular, embodiments enable automatic spatial alignment or coordination of drone trajectories and camera poses based purely on the visual content of the images those cameras capture, and the computation of consistent 3D point clouds, depth maps, and camera poses among all drones, as facilitated by the proposed iterative global optimizer. Successful operation does not rely on the presence of depth sensors (although they may be a useful adjunct) as the proposed SLAM-MT mechanisms in the camera controller can generate scale-consistent RGB-D image data simply using the visual content of successively captured images from multiple (even much greater than 2) drones. Such data are invaluable in modern high-quality 3D scene reconstruction.

The novel local-to-global coordinate transform method described above is based on matching multiple pairs of images such that a multi-to-one global match is made, which provides robustness. In contrast with prior art systems, the image processing performed by the drone agents to calculate their corresponding camera poses and depth maps does not depend on the availability of a global 3D map. Each drone agent can generate a dense depth map by itself given a pair of RGB images and their corresponding camera poses, and then transform the depth map and camera poses into global coordinates before delivering the results to the global optimizer. Therefore, the operation of the global optimizer of the present invention is simpler, dealing with the camera poses and depth maps in a unified coordinate system.

It should be noted that two loops of data transfer are involved. The outer loop operates between the fly controller and the camera controller to provide global positioning accuracy while the inner loop (which is made up of multiple sub-loops) operates between drone agents and the global optimizer within the camera controller to provide structure and motion accuracy.

Although the description has been described with respect to particular embodiments thereof, these particular embodiments are merely illustrative, and not restrictive. Applications include professional 3D scene capture, digital content asset generation, a real-time review tool for studio capturing, and drone swarm formation and control. Moreover, since the present invention can handle multiple drones performing complicated 3D motion trajectories, it can also be applied to process cases of lower dimensional trajectories such as scans by a team of robots.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A system of imaging a scene, the system comprising:
a plurality of drones, each drone moving along a corresponding flight path over the scene, and each drone having a drone camera capturing, at a corresponding first pose and a corresponding first time, a corresponding first image of the scene;
a fly controller that controls the flight path of each drone, in part by using estimates of the first pose of each drone camera provided by a camera controller, to create and maintain a desired pattern of drones with desired camera poses over the scene; and
the camera controller, the camera controller receiving, from the plurality of drones, a corresponding plurality of captured images of the scene, and processing the received plurality of captured images, to generate a 3D representation of the scene as a system output, and to provide the estimates of the first pose of each drone camera to the fly controller;
wherein the system is fully operational with as few as one human operator.

2. The system of claim 1, wherein the camera controller comprises:
a plurality of drone agents, each drone agent communicatively coupled to one and only one corresponding drone to receive a corresponding captured first image; and
a global optimizer communicatively coupled to each of the drone agents and to the fly controller;
wherein the drone agents and the global optimizer in the camera controller collaborate to iteratively improve, for each drone, an estimate of first pose and a depth map characterizing the scene as imaged by the corresponding drone camera, and to use the estimates and depth maps from all of the drones to create the 3D representation of the scene; and
wherein the fly controller receives, from the camera controller, the estimate of first pose for each of the drone cameras, adjusting the corresponding flight path and drone camera pose accordingly if necessary.

3. The system of claim 2,
wherein the depth map corresponding to each drone is generated by a corresponding drone agent based on processing the first image and a second image of the scene, captured by a corresponding drone camera at a corresponding second pose and a corresponding second time, and received by the corresponding drone agent.

4. The system of claim 2,
wherein the depth map corresponding to each drone is generated by a corresponding drone agent based on processing the first image and depth data generated by a depth sensor in the corresponding drone.

5. The system of claim 2,
wherein each drone agent:
collaborates with one other drone agent such that the first images captured by the corresponding drones are processed, using data characterizing the corresponding drones and image capture parameters, to generate estimates of the first pose for the corresponding drones; and
collaborates with the global optimizer to iteratively improve the first pose estimate for the drone camera of the drone to which the drone agent is coupled, and to iteratively improve the corresponding depth map.

6. The system of claim 5, wherein generating estimates of the first pose of each drone camera comprises transforming pose-related data expressed in local coordinate systems, specific to each drone, to a global coordinate system shared by the plurality of drones, the transformation comprising a combination of Simultaneous Location and Mapping (SLAM) and Multiview Triangulation (MT).

7. The system of claim 2, wherein the global optimizer:
generates and iteratively improves the 3D representation of the scene based on input from each of the plurality of drone agents, the input comprising data characterizing the corresponding drone, and the corresponding processed first image, first pose estimate, and depth map; and
provides the pose estimates for the drone cameras of the plurality of drones to the fly controller.

8. The system of claim 7, wherein the iterative improving carried out by the global optimizer comprises a loop process in which drone camera pose estimates and depth maps are successively and iteratively improved until the 3D representation of the scene satisfies a predetermined threshold of quality.

9. A method of imaging a scene, the method comprising:
deploying a plurality of drones, each drone moving along a corresponding flight path over the scene, and each drone having a camera capturing, at a corresponding first pose and a corresponding first time, a corresponding first image of the scene;
using a fly controller to control the flight path of each drone, in part by using estimates of the first pose of each camera provided by a camera controller, to create and maintain a desired pattern of drones with desired camera poses over the scene; and
using a camera controller to receive, from the plurality of drones, a corresponding plurality of captured images of the scene, and to process the received plurality of captured images, to generate a 3D representation of the scene as a system output, and to provide the estimates of the first pose of each camera to the fly controller;
wherein no more than one human operator is needed for full operation of the method.

10. The method of claim 9,
wherein the camera controller comprises:
a plurality of drone agents, each drone agent communicatively coupled to one and only one corresponding drone to receive a corresponding captured first image; and
a global optimizer communicatively coupled to each of the drone agents and to the fly controller; and
wherein the drone agents and the global optimizer in the camera controller collaborate to iteratively improve, for each drone, an estimate of the first pose and a depth map characterizing the scene as imaged by the corresponding drone camera, and to use the estimates and depth maps from all of the drones to create the 3D representation of the scene; and
wherein the fly controller receives, from the camera controller, the improved estimates of first pose, for each of the drone cameras, adjusting the corresponding flight path and drone camera pose accordingly if necessary.

11. The method of claim 10,
wherein the depth map corresponding to each drone is generated by a corresponding drone agent based on processing the first image and a second image of the scene, captured by a corresponding drone camera at a corresponding second pose and a corresponding second time, and received by the corresponding drone agent.

12. The method of claim 10,
wherein the depth map corresponding to each drone is generated by a corresponding drone agent based on processing the first image and depth data generated by a depth sensor in a corresponding drone.

13. The method of claim 10, wherein the collaboration comprises:
each drone agent collaborating with one other drone agent to process the first images captured by the corresponding drones, using data characterizing those drones and image capture parameters for the corresponding captured images, to generate estimates of the first pose for the corresponding drones; and
each drone agent collaborating with the global optimizer to iteratively improve the first pose estimate for the drone camera of the drone to which the drone agent is coupled, and to iteratively improve the corresponding depth map.

14. The method of claim 13, wherein generating estimates of the first pose of each drone camera comprises transforming pose-related data expressed in local coordinate systems, specific to each drone, to a global coordinate system shared by the plurality of drones, the transformation comprising a combination of Simultaneous Location and Mapping (SLAM) and Multiview Triangulation (MT).

15. The method of claim 11, wherein the global optimizer:
generates and iteratively improves the 3D representation of the scene based on input from each of the plurality of drone agents, the input comprising data characterizing the corresponding drone, and the corresponding processed first image, first pose estimate, and depth map; and
provides the first pose estimates for the plurality of drone cameras to the fly controller.

16. The method of claim 15, wherein the iterative improving carried out by the global optimizer comprises a loop process in which drone camera pose estimates and depth maps are successively and iteratively improved until the 3D representation of the scene satisfies a predetermined threshold of quality.

17. The method of claim 10 additionally comprising:
before the collaborating, establishing temporal and spatial relationships between the plurality of drones, in part by:
comparing electric or visual signals from each of the plurality of drone cameras to enable temporal synchronization;
running a SLAM process for each drone to establish a local coordinate system for each drone; and
running a Multiview Triangulation process to define a global coordinate framework shared by the plurality of drones.

18. An apparatus comprising:
one or more processors; and
logic encoded in one or more non-transitory media for execution by the one or more processors and when executed operable to image a scene by:
deploying a plurality of drones, each drone moving along a corresponding flight path over the scene, and each drone having a camera capturing, at a corresponding first pose and a corresponding first time, a corresponding first image of the scene;
using a fly controller to control the flight path of each drone, in part by using estimates of the first pose of each camera provided by a camera controller, to create and maintain a desired pattern of drones with desired camera poses over the scene; and
using a camera controller to receive, from the plurality of drones, a corresponding plurality of captured images of the scene, and to process the received plurality of captured images, to generate a 3D representation of the scene as a system output, and to provide the estimates of the first pose of each camera to the fly controller;
wherein no more than one human operator is needed for full operation of the apparatus.

19. The apparatus of claim 18, wherein the camera controller comprises:
a plurality of drone agents, each drone agent communicatively coupled to one and only one corresponding drone to receive the corresponding captured first image; and
a global optimizer communicatively coupled to each of the drone agents and to the fly controller; and
wherein the drone agents and the global optimizer in the camera controller collaborate to iteratively improve, for each drone, an estimate of the first pose and a depth map characterizing the scene as imaged by the corresponding drone camera, and to use the estimates and depth maps from all of the drones to create the 3D representation of the scene; and
wherein the fly controller receives, from the camera controller, the improved estimates of first pose, for each of the drone cameras, adjusting the corresponding flight path and drone camera pose accordingly if necessary.

20. The apparatus of claim 19,
wherein the depth map corresponding to each drone is generated by a corresponding drone agent based on:
either processing the first image and a second image of the scene, captured by a corresponding drone camera at a corresponding second pose and a corresponding second time, and received by the corresponding drone agent; or
processing the first image and depth data generated by a depth sensor in the corresponding drone.
